(19) United States
(12) Patent Application Publication
(10) Pub. No.: US 2012/0290106 A1
(43) Pub. Date: Nov. 15, 2012

(54) METHOD FOR THE MANAGEMENT OF INDUSTRIAL TRUCKS AND AN INDUSTRIAL TRUCK

(75) Inventor: Bernd Ulrich HALT, Oststeinbek (DE)

(73) Assignee: STILL GmbH, Hamburg (DE)

(21) Appl. No.: 13/465,369

(22) Filed: May 7, 2012

(30) Foreign Application Priority Data
May 13, 2011 (DE) 102011101505.5

(51) Int. Cl. G05B 9/02

(52) U.S. Cl. 700/79

(57) ABSTRACT

In a method for the management of industrial trucks, the industrial truck has a control computer which transmits data via a data transmission system to a central service computer. The following steps are carried out: detection of malfunctions of the industrial truck by the control computer, generation of fault codes by the control computer corresponding to the malfunctions, transmission of the fault codes via the data transmission system to the central service computer, and generation by the central service computer of instructions and/or information about required replacement parts.

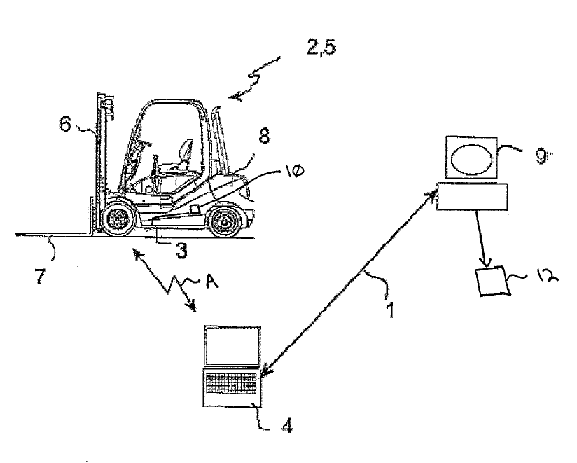

### CROSS-REFERENCE TO RELATED APPLICATION

This application claims priority to German Application No. 10 2011 101 505.5, filed May 13, 2011, which is herein incorporated by reference in its entirety.

### FIELD OF THE INVENTION

This invention relates to a method for the management of industrial trucks. The invention relates in particular to a method for the management of industrial trucks in which the industrial truck has a control computer which can transmit data via data transmission means to a central service computer. Malfunctions of the industrial truck can be detected by the control computer.

### BACKGROUND OF THE INVENTION

Large numbers of industrial trucks are used in warehouse operations and/or in production operations, primarily in industrial series manufacturing, to transport goods, raw materials and semi-finished products that have been delivered from the incoming goods department to the site of the actual production, such as to a conveyor belt. When these fleets of industrial trucks are used, which generally consist of a large number of fork-lift trucks, each of which is driven by a driver, there are typical tasks that have to be performed in the context of fleet management. For example, service intervals must be managed, as well as any repair work that may be necessary. In the systems of the known art, a fault or a defect is encountered by a customer (e.g., the user of an industrial truck) and some type of fault message is transmitted to the responsible service organization via known means such as telephone or fax, for example, in the form of a report to repair the problem. When a repair request or a service requirement is received in this manner, the service organization receives no or only very limited instructions or information about the fault or defect which has occurred in the industrial truck and the causes of the fault. The result is that the first step is frequently to dispatch a service technician to the faulty industrial truck with the specified diagnostic capabilities, in particular the appropriate diagnostic software. By polling fault memories, the technician can determine the cause of the fault and optionally identify the faulty or defective components. One consequence of this method, however, is that in many cases a service technician must be dispatched a second time, because he has not brought the required or correct component with him. Given the large number of possible variants and the large number of model years of industrial trucks that are in operation at the same time, it is only possible to bring along a small number of the most commonly replaced components as a precautionary measure.

The known art includes the wireless transmission of data from and to an industrial truck for diagnostic purposes as well as for service purposes.

It is an object of this invention to provide a method for the management of industrial trucks by means of which faults can be resolved and damage can be repaired both efficiently and economically.

### SUMMARY OF THE INVENTION

This object is accomplished by a method for the management of industrial trucks wherein the industrial truck includes a control computer that can transmit data via data transmission means to a central service computer. The control computer detects one or more malfunctions of the industrial truck. The control computer generates one or more fault codes corresponding to the detected malfunctions. The control computer transmits the fault codes via data transmission means to a central service computer. The central service computer generates instructions and/or information about replacement parts required. An industrial truck of the invention comprises a control computer on the industrial truck. A central service computer is provided, wherein the control computer transmits fault codes related to detected malfunctions of the industrial truck via data transmission means to the central service computer for the generation of instructions and/or information about required replacement parts. A service computer of the invention receives fault codes related to malfunctions of the industrial truck from a control computer via data transmission means and generates instructions and/or information about required replacement parts.

This object is accomplished by a method for the management of industrial trucks, wherein the industrial truck has a control computer which can transmit data to a central service computer via data transmission means. The method includes the following steps: detection of malfunction(s) of the industrial truck by the control computer; generation by the control computer of fault code(s) that correspond to the malfunction(s); transmission of the fault code(s) via the data transmission means to the central service computer; and generation by the central service computer of instructions and/or information on the replacement parts required.

Advantageously, the fault codes can be analyzed in the central service computer and a necessary replacement part can be identified or a selection of several replacement parts that may potentially be required can be made. This eliminates unnecessary trips by a service technician because the service technician then generally brings all the required parts with him on the first trip to repair the vehicle. The selection of the replacement parts can be made automatically on the central service computer from databases or lists that are stored in software on the service computer. It is also easily possible to maintain the software on the central service computer and keep it always up to date so that the most current replacement parts are always selected. Likewise, instructions for the service and repair of the industrial truck can be provided by the software on the central computer, in particular the sections of the repair manual or repair instructions associated with the fault code. These instructions can be kept up to date and every repair can be performed according to the most recent instructions. In particular, it is possible to update the instructions on the central service computer on the basis of experience with previous repairs and reports prepared by service technicians, in the sense of an expert system. That can be accomplished, for example, by taking feedback from the service technician into consideration in the form of predefined electronic forms, service reports, or in another specified manner, and having this feedback processed by the software, in particular in a rules-based program for the evaluation of the fault code. The result is a self-learning system. In particular, it is advantageous to have the fault code processed automatically by the software on the central service computer. Consequently, not only are the error codes available as data that can be read by a user on the central service computer, but a sequence of operations or workflow is automatically initiated. The fault code is thereby analyzed on the central service computer with rules-based programs. Solution trees with probabilities of occurrence can be created for the evaluation of which rules relate to a fault code. The invention can advantageously reduce operating costs, in particular by eliminating unnecessary trips by the service technician without the equipment necessary for the determination of the cause of the problem or the replacement parts necessary to repair it. The automatic fault reporting and the instructions generated will also increase the availability of the industrial truck by making possible a fast and appropriate repair. Because the entire process from the reporting of a fault code is controlled by a workflow which can be made available to third persons, in particular all the parties involved, in the form of a presentation, it is also advantageous and easily possible to measure the availability of the industrial truck or the down times until the message that the repair has been completed is received. The presentation to third persons can also be in the form of status reports. As a result of the fully automatic launch or the fully automatic monitoring of the entire process in the central service computer, a rapid service operation advantageously becomes possible even in multi-shift operation of the industrial trucks without significant added cost or effort, because a repair order can also be initiated during the night, for example, without the need for the service team to establish a corresponding stand-by service. As a result of the feedback in the form of service reports after the repair has been completed and a comparison with the instructions which the software makes available on the central service computer, it also becomes possible to verify and improve the quality of the instructions by means of a comparison of the specified procedure and the actual results.

In one advantageous configuration of the method of the invention, the control computer also collects measurements from the industrial truck and transmits them to the service computer, in particular the measurements associated with the fault codes and/or measurements of vehicle components associated with the fault codes.

A more detailed rules-based evaluation can be performed by means of a combination of the fault code with corresponding measurements, and in particular a learning expert system can be generated.

The instructions advantageously include a description of the problem and/or documents with installation instructions and/or calibration instructions and/or the amount of time required for the repair.

With this method, down times and repair times can be estimated and planned. It is also possible to generate an automated repair proposal for the owner of the industrial truck and to offer or agree on a repair time window.

In one advantageous configuration of the method of the invention, the data transmission means are wireless links and the data are transmitted via GPRS, UMTS, LTE, Bluetooth or WLAN.

The data can therefore be transmitted securely and reliably without the requirement for a fixed cable connection to the industrial truck. When a problem occurs, the method of the invention makes it possible to send a fault code immediately and to initiate a repair order.

The data transmission means can establish a link to a central service computer via the Internet.

The service computer advantageously makes available a workflow that can be displayed on other computers or on the service computer itself, in particular a workflow that can be displayed in the form of an application on the Internet.

In a further configuration of the method of the invention, the central service computer transmits instructions and/or information about the necessary replacement parts to a receiving device for a service technician in the form of messages, in particular in the form of e-mail or SMS.

Instructions can be transmitted to the service technicians along with probabilities of occurrence for specified events, such as faults, problems that may arise and must be taken into consideration during the repair as well as other, additional or more detailed instructions. Suggestions for replacement parts can likewise be transmitted to the service technician.

The central service computer can advantageously transmit data to the control computer of the industrial truck via the data transmission means.

In one advantageous development of the method, the service computer selects the appropriate instructions and/or information, in particular a list of appropriate replacement parts, on the basis of a transmitted or identified serial number of the industrial truck.

It is thereby advantageously possible to always select the most current replacement parts catalogue for an industrial truck and to determine the appropriate order data for a required replacement part. It also thereby becomes possible to always make up to date instructions available.

The object of the invention is also accomplished by an industrial truck with a control computer which can transmit fault codes relating to the faulty functions detected in the industrial truck over data transmission means to a central service computer for the generation of instructions and/or information about required replacement parts.

With the industrial truck of the invention, the fault codes can also be advantageously analyzed on the central service computer, and because a required replacement part is identified or a selection of several replacement parts that may be required is made, unnecessary trips by a service technician are avoided, because the service technician will then regularly bring all the parts necessary for the repair with him on the first trip. The selection of replacement parts can be made automatically on the central service computer on the basis of databases or lists that are stored in the form of software and are generated automatically. It is also easily possible to maintain the software on the central service computer and keep it always up to date so that the most current spare parts are always selected. Likewise, instructions for the service and repair of the industrial truck can be made available by the software on the central computer, in particular the sections of the repair manual associated with the fault codes. These instructions can always be kept up to date and whenever a repair is performed, the procedure will always be carried out according to the most recent instructions. In particular, it is possible to update the instructions on the central computer on the basis of experience with previous repairs, reports prepared by service technicians, etc. in the sense of an expert system. This can be accomplished, for example, by taking feedback from the service technician into consideration in the form in predefined electronic forms, service reports or in another specified manner, and having it processed by the software, in particular in a rules-based program for the evaluation of the fault code. The result is a self-learning system. It is advantageous in particular to have the fault codes processed automatically by the software on the service computer. Therefore this information is available not only in the form of data that can be read by a user on the central service computer but a sequence of repair operations or workflow is initiated automatically. The fault code is thereby analyzed on the central service computer with rules-based programs. Solution trees with probabilities of occurrence can be created for an assessment of which rules relate to a fault code. The invention can advantageously reduce operating costs, in particular by eliminating unnecessary trips by service technicians without the necessary equipment for the determination of the cause of the fault and optionally the necessary repairs. The automatic fault reporting and the instructions generated also increase the availability of the industrial truck because they make a fast and appropriate repair possible. Because the entire sequence of operations beginning with the reporting of a fault code is controlled by a workflow which can be made available to third persons, in particular all the parties involved, in the form of a presentation, it is also easily and advantageously possible to measure the availability of the industrial truck or the down time until the message that the repair has been completed is received. The presentation to third persons can also be in the form of status reports. As a result of the fully automatic launch or the fully automatic monitoring of the entire process in the central service computer, a rapid service operation advantageously becomes possible even in multi-shift operation of the industrial trucks without significant added cost or effort, because a repair order can also be initiated during the night, for example, without the need for the service team to establish a corresponding stand-by service. As a result of the feedback in the form of service reports after the repair has been completed and a comparison with the instructions which the software makes available on the central service computer, it also becomes possible to verify and improve the quality of the instructions by means of a comparison of the specified procedure and the actual results.

The control computer can also advantageously compile measurements of the industrial truck and transmit them to the service computer, in particular the measurements that relate to the fault codes and/or measurements of vehicle components associated with the fault codes.

As a result of the combination of fault codes with corresponding measurements, a more precise rules-based evaluation is possible and in particular a learning expert system can be generated.

The instructions can include a fault description and/or documents with installation instructions and/or calibration instructions and/or the amount of repair time required.

It thereby becomes possible to estimate down times and repair times. It is also possible to generate an automated repair proposal for the owner of the industrial truck and to offer a repair time window.

The data transmission means can advantageously be wireless data links and the data can be transmitted via GPRS, UMTS, LTE, Bluetooth or WLAN.

It thereby becomes possible to transmit the data securely and reliably without the need for a fixed cable connection to the industrial truck. When a fault occurs, it is therefore possible to immediately transmit a fault code and initiate a repair order.

In one advantageous configuration of the industrial truck of the invention, the data transmission means include a link to the central service computer via the Internet.

The object of the invention is also accomplished by a service computer which is used with an industrial truck as described above.

In one advantageous configuration of the service computer, a procedure can be displayed on another computer or on the service computer itself, in particular a procedure that can be displayed in the form of an application on the Internet.

The central service computer can advantageously transmit instructions and/or information on the spare parts required to a receiver unit for a service technician in the form of messages, in particular in the form of an e-mail or SMS.

Instructions can thereby be transmitted to the service technicians with probabilities of occurrence for specific events such as faults, problems that must be taken into consideration or may occur during the repair, as well as any more extensive instructions. Likewise, the list of suggested replacement parts can be transmitted to the service technician. The service technician's receiving unit can thereby be a notebook computer, although it can also be a smartphone or any other terminal that can be used with networks.

Data can be transmitted to the control computer of the industrial truck via the data transmission means.

In one advantageous development of the service computer of the invention, instructions and/or information, in particular a list of replacement parts, can be selected by means of a serial number corresponding to the industrial truck.

Messages from the control computer of the industrial truck can be transmitted to a special database server. A computer in a network, such as the central service computer, for example, can act as an applications server on which the entire process is controlled by a web application. It thereby becomes easily possible to make information available to other persons who also have access to this web application.

The central service computer can generate service orders, orders for replacement parts and documents for the repair order to be performed by means of interfaces with materials management systems such as a SAP-interface, for example.

The availability of the industrial truck is thereby advantageously increased, because a repair process can be initiated immediately after the automatic detection of a fault and receipt of the fault message. This feature is advantageous, in particular on an industrial truck, because a failure on vehicles of this type can very quickly have repercussions on a company's production processes. If industrial trucks, e.g., in large fleets of industrial trucks in industrial companies, are operated in multiple shifts, the invention makes it possible to react automatically in the event of a fault. A repair intervention can be initiated automatically, including the issue of purchase orders for replacement parts and the generation of instructions for repair personnel and an automated determination of repair times with reference to both the length of time required for the repair and the timing.

### BRIEF DESCRIPTION OF THE DRAWING

Additional advantages and details of the invention are explained in greater detail below on the basis of the exemplary embodiment illustrated in the accompanying FIGURE. The FIGURE is a schematic diagram of the link between an industrial truck and a central service computer.

DESCRIPTION OF THE PREFERRED EMBODIMENTS

An industrial truck 2 has a transmitter 3, by means of which a link indicated by an arrow A can be established with a computer 4 located in the area in which the industrial truck 2 is being operated. The industrial truck 2, for example, can be a fork lift truck 5 which has a lifting platform 6 with a vertically adjustable load fork 7 that can be guided on the lifting platform. A counterweight 8 compensates for a load moment of a load weight (not shown) on the load fork 7.

The computer 4 is in communication via the Internet, which is indicated by the double arrow 1, with a central service computer 9 at a service company. A control computer 10 of the industrial truck 2, which controls the functions of the vehicle, detects faults and generates the corresponding fault codes. In addition, measurements are recorded that correspond to the fault codes, such as measurements by sensors of components for which a fault is reported. Both the measurements and the fault codes generated are transmitted via the transmitter 3 to the computer 4, which can be located, for example, on the company site on which the industrial truck 2 is being operated.

The computer 4 forwards the data via the Internet 1 to the central service computer 9. On the basis of a stored database, software on the central service computer 9 determines the actions that must be executed to eliminate the fault identified on the basis of the combination of the measurements and the fault code. An assessment is thereby made on the basis of probabilities that given the current fault message, a specific replacement part will be required, or alternatively another replacement part. The repair instructions corresponding to both alternatives are also made available. A selection of replacement parts is thereby made on the basis of a current replacement parts list which is created on the basis of the serial number of the industrial truck 2 which is also identified and transmitted. Finally a repair order 12 is generated and initiated by the service computer 9. This repair order 12 generated for the determined most probable cause of the fault is also transmitted to a service technician along with general instructions and repair instructions if necessary, the suggested replacement parts and with the determined probability of occurrence. Simultaneously, information is made available to the owner or user of the industrial truck 2 by means of a web application on the amount of time required for repair and a potential repair deadline and optionally the resulting costs, which are calculated by the central service computer 9.

On the basis of rules-based algorithms, the service computer 9 can thereby identify the most probable cause of the fault on the basis of the fault code and optionally the measurements.

Once the most probable cause of the fault has been identified, the service computer 9 can also project and make available a down time of the industrial truck 2 that corresponds to the cause of the fault.

The service computer 9 can also initiate a release from inventory of the replacement parts that correspond to the determined most probable cause of the fault.

It will be readily appreciated by those skilled in the art that modifications may be made to the invention without departing from the concepts disclosed in the foregoing description. Accordingly, the particular embodiments described in detail herein are illustrations only and are not limiting to the scope of the invention, which is to be given the full breadth of the appended claims and any and all equivalents thereof.

1. A method for management of an industrial truck, wherein the industrial truck includes a control computer which can transmit data via data transmission means to a central service computer, the method comprising the steps of:
detection by a control computer of one or more malfunctions of an industrial truck;
generation by the control computer of one or more fault codes corresponding to the one or more malfunctions;
transmission to a central service computer of the one or more fault codes via the data transmission means; and
generation by the central service computer of instructions and/or information about replacement parts required.

2. The method of claim 1, wherein the control computer also collects measurements from the industrial truck and transmits the measurements to the service computer, wherein the measurements are related to the fault code and/or are measurements of vehicle components associated with the fault codes.

3. The method of claim 1, wherein the instructions include at least one of a description of the fault, documents with installation instructions, calibration instructions, and the time required for the repair.

4. The method of claim 1, wherein the data transmission means are wireless data links and the data are transmitted via at least one of GPRS, UMTS, LTE, Bluetooth or WLAN.

5. The method of claim 1, wherein the data transmission means establish a link to a central service computer via the Internet.

6. The method of claim 1, wherein the service computer provides a workflow displayable on other computers or on the service computer itself, or as an application on the Internet.

7. The method of claim 1, wherein the central service computer transmits instructions and/or information on required replacement parts to a receiving unit for a service technician in the form of a message via e-mail or SMS.

8. The method of claim 1, wherein the service computer transmits data to the control computer of the industrial truck via the data transmission means.

9. The method of claim 1, wherein the service computer selects instructions and/or information including a list of replacement parts corresponding to a transmitted or identified serial number of the industrial truck.

10. An Industrial truck, comprising:
a control computer on the industrial truck; and
a central service computer, wherein the control computer transmits fault codes relating to detected malfunctions of the industrial truck via data transmission means to the central service computer for the generation of instructions and/or information about required replacement parts.

11. The industrial truck of claim 10, wherein the control computer also records measurements of the industrial truck and transmits the measurements to the service computer, wherein the measurements are related to the fault codes and/or vehicle components associated with the fault codes.

12. The industrial truck of claim 10, wherein the instructions include at least one of a description of the fault documents with installation instructions, calibration instructions, or the amount of time required for the repair.

13. The industrial truck of claim 10, wherein the data transmission means are wireless data links and the data are transmitted via at least one of GPRS, UMTS, LTE, Bluetooth or WLAN.

14. The industrial truck of claim 10, wherein the data transmission means include a link to the central service computer via the Internet.

15. A service computer for an industrial truck as set forth in claim 10.

16. The service computer of claim 15, wherein a workflow that is displayed on other computers or on the service computer itself is available in the form of a workflow presentable as an application on the Internet.

17. The service computer of claim 15, wherein the central service computer transmits instructions and/or information about replacement parts required to a receiver unit for a service technician in the form of messages, wherein the transmission is in the form of e-mails or SMS.

18. The service computer of claim 15, wherein data is transmitted via the data transmission means to the control computer of the industrial truck.

19. The service computer of claim 15, wherein instructions and/or information in the form of a list of replacement parts, is selected on the basis of a transmitted or determined serial number of the industrial truck.
